(19) United States
(12) Patent Application Publication
(10) Pub. No.: US 2011/0276628 A1
(43) Pub. Date: Nov. 10, 2011

(54) SOCIAL ATTENTION MANAGEMENT

(75) Inventor: Barney Darryl Pell, San Francisco, CA (US)

(73) Assignee: Microsoft Corporation, Redmond, WA (US)

(21) Appl. No.: 12/774,038

(22) Filed: May 5, 2010

(51) Int. Cl. G06F 15/16

(52) U.S. Cl. 709/204

(57) ABSTRACT

Concepts and technologies are described herein for providing social attention management. An attention management device (“AMD”) can receive a request associated with one or more users of a social networking service. In response to receiving the request, the AMD collects and/or analyzes interaction data obtained from one or more systems or devices in communication with the AMD. The AMD surfaces or presents the interaction data to a user for consumption during the request review process. In response to receiving input from the user, the AMD can alter communications with one or more contacts. Methods for social attention management also are disclosed.

### BACKGROUND

The social networking revolution has profoundly affected the Internet in that finding and communicating with people has been dramatically simplified. In addition to direct communication channels such as telephone, mail, email, instant messaging, and the like, people can connect to one another via social networking services and maintain communication channels despite later changes to location, email addresses, telephone numbers, and the like. Additionally, social networking services can add discoverability and extended communications capabilities, whereby social networking service users can find new friends or connections and/or send messages to connections-of-connections, friends-of-friends, and the like.

Social networking services have also simplified publishing content by making publication and widespread dissemination of content both free and substantially instantaneous. Thus, social networking service users can instantly communicate with large audiences and/or subscribe to news or content feeds. In addition to positive uses of these services, social networking services have also become targets for purveyors of unsolicited bulk email (UBE) or other adversarial users who take advantage of social networking services to obtain instantaneous, free, and widespread dissemination of advertising, viruses, junk mail, and the like. Therefore, the social networking revolution has resulted in an increasing amount of information, both good and bad, that is being presented to and/or consumed by the average social networking service user. With all of this increased communication activity comes an increase in information, choice, and competition for limited social attention of social networking users.

It is with respect to these and other considerations that the disclosure made herein is presented.

### SUMMARY

Concepts and technologies are described herein for providing social attention management. Social attention management, as used herein, refers to simplifying, streamlining, and/or adding context to information and choices presented to social networking users to assist social networking users in managing limited social attention. By providing information, choices, and/or requests with additional information and/or context, social networking users may make informed decisions with regard to the presented information, choices, and/or requests, without having to dedicate their full attention.

According to one aspect, an attention management device (“AMD”) executes an attention management module for collecting and/or analyzing interaction data collected by one or more systems or devices communicating with the AMD. As used herein, “interaction data” includes social networking data describing social networking service users, user accounts, content, and social networking service activity. “Interaction data” also includes communication data obtained from one or more communication servers such as an email server, a short message service center (“SMSC”), and the like. The communication data can describe communications between one or more users and his or her contacts. The interaction data also may include data collected during interactions using a client device such as a smart phone. The data collected can include audio, video, or photographs, location information, time, temperature, light, noise, pressure, orientation information, and the like, and can be obtained using one or more sensors associated with the client device.

According to another aspect, the AMD receives a request associated with one or more users of a social networking service. The request can include friend or connection requests, requests to remove contacts from a contact list associated with the user, or the like. In response to receiving the request, the AMD collects and/or analyzes the interaction data and surfaces or presents the interaction data to a user for consumption during the request review process. In response to receiving input from the user, the AMD can alter communications with one or more contacts.

According to another aspect, the AMD can rely upon a proxy when a request is received. As used herein, a “proxy” is can be any entity that a social networking service user indicates is trusted with regard to social attention management. The proxy may be selected by the user, or determined by the AMD. Instead of, or in addition to, obtaining input from the user, the AMD can rely upon the proxy. For example, the AMD can determine how the proxy would handle the request and take an action in accordance with the determination.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for managing social connections, according to an exemplary embodiment.

FIG. 3 is a flow diagram showing aspects of a method for using a proxy to manage social connections, according to an exemplary embodiment.

FIG. 4 is a flow diagram showing aspects of a method for collecting interaction data at the client device, according to an exemplary embodiment.

FIG. 5 is an illustration showing an exemplary screen display of a user interface for an attention management device, according to an exemplary embodiment.

FIG. 6 is a computer architecture diagram illustrating an exemplary computer hardware and software architecture for a computing system capable of implementing aspects of the embodiments presented herein.

### DETAILED DESCRIPTION

The following detailed description is directed to technologies for social attention management. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for social attention management will be presented.

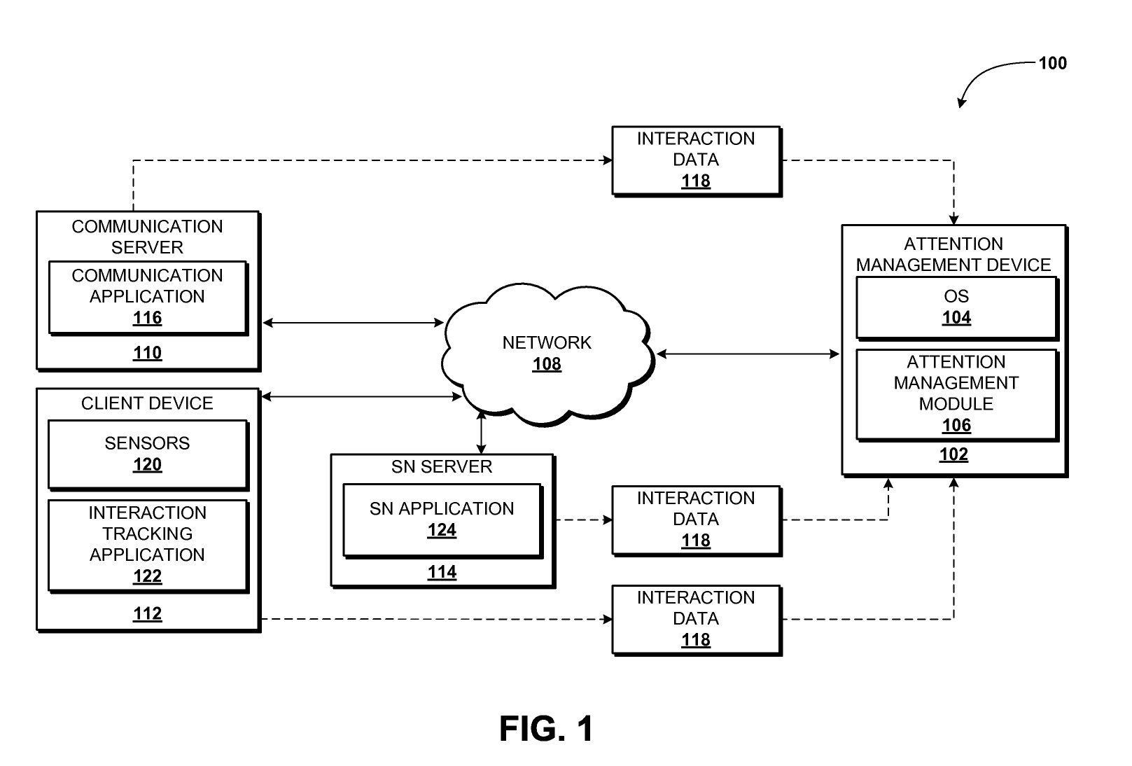

Referring now to FIG. 1, aspects of one operating environment 100 for the various embodiments presented herein will be described. The operating environment 100 shown in FIG. 1 includes an attention management device 102 (“AMD”). According to various embodiments, the AMD 102 is a mobile telephone, a smart phone, a laptop computer, a desktop computer, a server computer, a handheld computer, a netbook computer, or a tablet computer. According to various other embodiments, the AMD 102 is an embedded computer system, a video game console, a personal digital assistant, and/or another computing device.

The AMD 102 is configured to execute an operating system 104 and one or more application programs, including but not limited to an attention management module 106. The operating system 104 is a computer program for controlling the operation of the AMD 102. The attention management module 106 is an executable program configured to execute on top of the operating system 104. Execution of the attention management module 106 causes the AMD 102 to provide the functionality described herein for providing social attention management.

The AMD 102 may operate on or in communication with one or more networks 108. The networks 108 can include any combination of wired and wireless networks including, but not limited to, cellular networks and packet data networks such as the Internet, local area networks (“LANs”), wide area networks (“WANs”), and/or other public and/or private networks. The AMD 102 may operate in conjunction with other computing systems on or in communication with the network 108. In some embodiments, the AMD 102 communicates with a communication server 110, a client device 112, a social networking (“SN”) server 114, and/or other devices (not illustrated).

The communication server 110 can be accessible via the network 108 and can host one or more applications. In the illustrated embodiment, the communication server 110 hosts a communication application 116 for providing communication services to one or more users. In some implementations, the communication application 116 is executable by the communication server 110 to provide instant messaging services, e-mail services, short messaging services (“SMS”), multimedia messaging services (“MMS”), and/or other communication services. Therefore, it should be understood that the operating environment 100 may include a number of communication servers 110, and that one or more of the communication servers 110 may operate on or in communication with the Internet, a cellular communication network, and/or other networks.

As will be explained in more detail below, the communication application 116 is configured to track interaction data 118. The interaction data 118 can be interpreted by other network systems and/or devices, including the AMD 102, to understand communications occurring via the communication server 110. Thus, the interaction data 118 can include data representing the frequency of communications occurring over the communication server 110, the parties to communications occurring over the communication server 110, elapsed time between communications occurring over the communication server 110, other data, and the like. The functionality for tracking communications occurring via the communication server 110 can be enabled, if desired, by one or more users associated with communications occurring over the communication server 110. Similarly, the functionality for tracking communications may be disabled by the one or more users to address perceived security and/or privacy concerns. The interaction data 118, and the use thereof, is explained in more detail herein.

The functionality of the client device 112 can be provided by one or more computing systems including, but not limited to, a mobile phone, a PDA, a smart phone, a laptop computer, a palmtop computer, a desktop computer, a tablet computer, and/or other computing devices. The client device 112 is described herein as a mobile telephone. It should be understood that this example is illustrative.

The client device 112 includes one or more sensors 120, and is configured to execute an interaction tracking application 122 for tracking interactions, as described herein. The sensors 120 can be used to detect interactions by measuring and/or detecting states associated with the client device 112, as well as detecting interactions between the client device 112 with other devices in proximity with the client device 112. The sensors 120 also can detect states and/or conditions associated with an environment within which the client device 112 is located. In various implementations, the sensors 120 include one or more accelerometers, compasses, proximity sensors, infrared (“IR”) transceivers, Global Positioning System (“GPS”) receivers, clocks, short range radio transceivers, long range radio receivers, noise and/or pressure meters, microphones, light meters, thermometers, and/or other software and hardware.

Thus, the sensors 120 can be used to measure orientation of the client device 112, as well as movement, velocity, altitude, position, and/or acceleration of the client device 112. The sensors 120 also can be used to measure light, noise, time, and/or temperature at the client device 112. Additionally, the sensors 120 can be used to detect the presence or absence of bodies, people, networks, and/or radios sources at or near the client device 112, as well as the presence of power, battery, and charging sources at the client device 112. It should be understood that additional conditions at or proximate to the client device 112 may be determined using the sensors 120, and that the provided examples are illustrative.

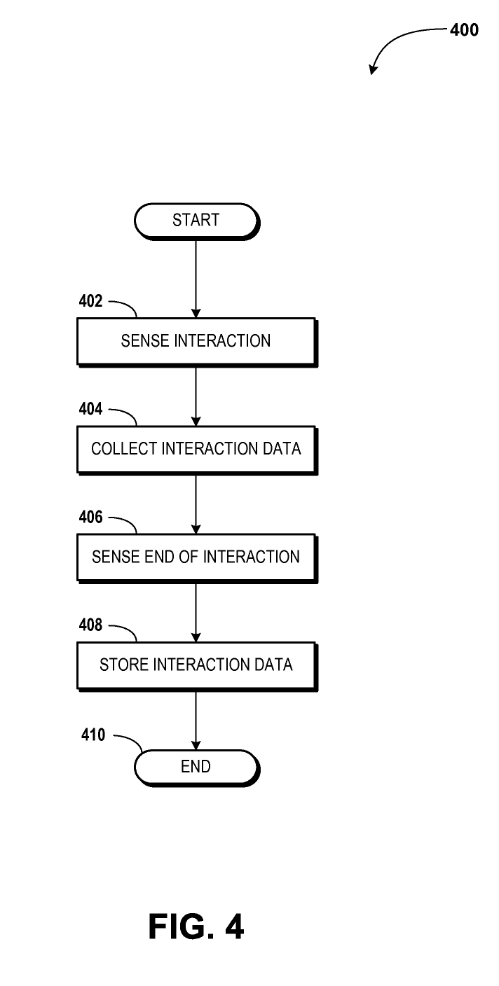

As will be explained in more detail with reference to FIG. 4, the client device 112 can detect interactions occurring at or proximate to the client device 112, and can record interaction data 118 using the interaction tracking application 122. As mentioned above with respect to the communication server 110, the functionality of the interaction tracking application 122 for recording interaction data 118 can be selectively enabled to provide the functionality described herein. Similarly, the interaction tracking application 122 may be selectively disabled by one or more users or other authorized entities associated with the client device 112 to address perceived security and/or privacy concerns.

The interaction tracking application 122 is configured to recognize interactions occurring between a user of the client device 112 and another entity based upon data sources and/or the sensors 120. For example, the interactions may be recognized by the interaction tracking application 122 by sensing usage of one or more messaging or other communications applications at the client device 112. Additionally, the interaction tracking application 122 may sense interactions by recognizing that another device is proximate to the client device 112, for example, by sensing a short- and/or long-range radio source at or near the client device 112 with one or more sensors 120. In some embodiments, the interaction tracking application 122 senses input received from a user of the client device 112, wherein the input indicates that an interaction is occurring or is about to occur.

Other software and/or hardware may be used to detect interactions. For example, in some embodiments, the interaction tracking application 122 is configured to access calendar data corresponding to a calendar associated with the user of the client device 112. Based upon the calendar data, the interaction tracking application 122 can anticipate interactions, and record data during the anticipated interactions. For example, the interaction tracking application 122 may determine that a meeting is scheduled for a particular time. At or near the scheduled time, the client device 112 can access the sensors 120 to search for proximate devices, to identify activity occurring proximate to the client device 112, to prompt a user for information, and the like. Thus, the interaction tracking application 122 may track interaction data 118 corresponding to communications made using the client device 112, as well as interaction data 118 corresponding to interactions occurring proximate to the client device 112.

The SN server 114 hosts a social networking application 124 (“SN application”) for providing a social networking service. In some embodiments, the SN application 124 provides a real-time messaging service such as the TWITTER real-time messaging service. In some embodiments, the SN application 124 provides a SN application such as the FACEBOOK social networking service. Other social networking services are contemplated. The SN application 124 is configured to track usage of one or more social networking services, and to collect interaction data 118 reflecting interactions occurring via the SN server 114. As mentioned above with respect to the communication server 110 and the interaction tracking application 122, the tracking feature of the SN server 114 can be selectively enabled or disabled to provide the functionality described herein and/or to address perceived security and/or privacy concerns.

In some embodiments, the interaction data 118 includes data relating to one or more social networks associated with a user of the SN application 124. Additionally, the interaction data 118 may include data relating to communications and interactions occurring via the SN application 124. The interaction data 118 can be interpreted by the AMD 102 to indicate social networking connections of one or more users, communications occurring via the SN application 124, elapsed time between communications occurring via the SN application 124, and the like.

Additionally, the interaction data 118 can indicate other usage of the SN application 124 by one or more users, including, but not limited to, status updates, messages, real-time messages, and the like, and therefore may relate to news, thoughts, moods, events, and other information associated with a social networking service and/or users of the social networking service. Furthermore, the interaction data 118 can include information relating to links, photographs, graphics, animations, documents, videos, and/or other resources, all of which may be shared or referenced by users of a social networking service, advertisers affiliated with or advertising through a social networking service, and/or other entities. In some embodiments, various data relating to one or more social networks of a user are included in the interaction data 118 or as social networking data (not illustrated). These data may include, but are not limited to, data indicating contact lists, friend lists, connection lists, location information, personal and/or professional background information, and the like for a user.

According to various embodiments, the AMD 102 receives a request associated with one or more users of a social networking service. The request can include a friend or connection request received from a prospective contact, a request to remove (“prune”) contacts from a friend or contact list, a request to organize contacts in a contact list, a request to expand communications with a contact, and/or other requests. The AMD 102 can obtain or analyze the interaction data 118 to identify communications between the user and the prospective contact.

The interaction data 118 can include communications occurring via the communication server 110, interactions occurring via or in proximity to the client device 112, and/or interactions occurring via one or more social networking services provided by one or more SN servers 114. It should be understood that the interaction data 118 can be collected from multiple SN servers 114, wherein each of the SN servers 114 may operate according to different protocols and/or provide varying functionality.

The AMD 102 can provide the interaction data 118 to a user during review of the request, if desired. In some embodiments, the AMD 102 presents sampled interaction data 118. In other embodiments, the AMD 102 summarizes the interaction data 118 and presents a summary that may include an overview of interactions between the user and the prospective contact, statistics relating to interactions between the user and the prospective contact, or other information. The AMD 102 can obtain input from the user indicating an action the user wishes to take with respect to the request, and the AMD 102 can execute the indicated action. In some embodiments, the AMD 102 relies upon a proxy instead of, or in addition to, presenting the request and the interaction data 118 to the user. These and other embodiments will be described herein.

FIG. 1 illustrates one AMD 102, one network 108, one communication server 110, one client device 112, and one SN server 114. It should be understood, however, that some implementations of the operating environment 100 include multiple AMDs 102, multiple networks 108, multiple communication servers 110, multiple client devices 112, and multiple SN servers 114. Therefore, the illustrated embodiment should be understood as being exemplary, and should not be construed as being limiting in any way.

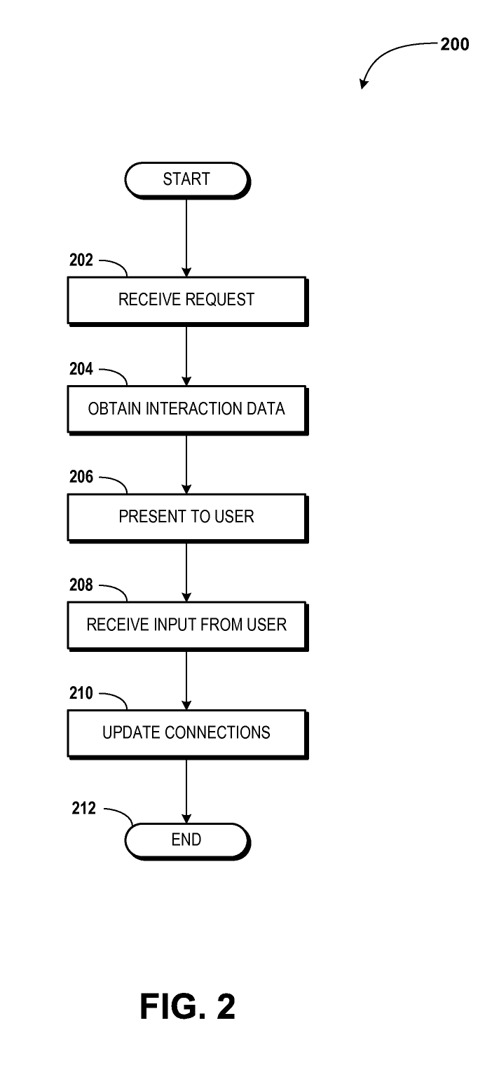

Turning now to FIG. 2, a method 200 for managing social connections will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined above. The term “computer-readable instructions,” and variants thereof, as used in the description and claims, is used expansively hereinto include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the AMD 102. It should be understood that this embodiment is exemplary, and should not be viewed as being limiting in any way. The method 200 begins at operation 202, wherein the AMD 102 receives a request to manage social connections associated with a user. According to some embodiments, as mentioned above, the functionality of the AMD 102 is provided by a stand-alone application that is configured to access multiple systems and devices to obtain interaction data 118.

In some embodiments, for example, the AMD 102 communicates with a number of SN servers 114 to collect interaction data 118 associated with a number of social networking services. Additionally, the AMD 102 can be configured to communicate with a number of client devices 112 and/or communication servers 110 to collect the interaction data 118. Thus, it should be understood that according to various implementations, the request can include a friend request from another user of a social networking service.

The request also can include a request from a user to remove (“prune”) contacts from a contact list associated with the user. For example, a user may decide to reduce the number of contacts or friends on a contact or friend list. Additionally, the request can include a request to categorize contacts of a contact list associated with the user. For example, a user may want to segment his friends or contacts into lists to facilitate efficient reading, publishing, and/or privacy settings, and/or to organize contacts and friends based upon interaction data 118. Additionally, the request can include a request to determine whether to expand a connection with a contact to alternative channels of communication such as another social networking site, or the like. For example, the user may want to determine contacts or friends with whom existing relationships should be expanded. It should be understood that the above examples are illustrative of possible requests, and should not be construed as being limiting in any way.

In response to the request, the AMD 102 can provide the functionality provided herein. It should be understood that the functionality of the AMD 102 can be automatically invoked by the AMD 102 when a request is received. Additionally, or alternatively, the functionality of the AMD 102 may be invoked by a user, for example, by selecting an option to obtain more information relating to a request. In some embodiments, for example, the functionality of the AMD 102 is provided to a user via a user interface provided by the attention management module 106 and/or one or more other modules.

Although not illustrated in FIG. 2, the method 200 can include a user disambiguation operation. The user disambiguation operation may be useful where a contact has more than one identity and/or is associated with more than one social networking account. Thus, multiple accounts and/or identities associated with a contact may be identified, thereby allowing interaction data 118 associated with a contact to be captured, even where the contact has multiple identities.

During a user disambiguation operation, the AMD 102 can identify the one or more accounts and/or identities associated with a contact, and can present all interaction data 118 associated with the identities and/or accounts to the AMD 102. For example, a user John Smith may use the identify “John Smith” with a first social networking or communication platform, and may use the identities “J. Smith,” “JSmith,” “johnsmith,” “JS0176,” and the like with other social networking or communication platforms. Thus, the AMD 102 can be configured to determine any identities associated with a contact. According to various embodiments, the AMD 102 may determine the identities based upon various data associated with the contact including, but not limited to, an Internet protocol (“IP”) address, telephone number, physical address, email address, location, time information, background information, and the like, associated with the contact, any and/or all of the which may be used to identify related accounts and/or identities.

From operation 202, the method 200 proceeds to operation 204, wherein the AMD 102 obtains interaction data 118 from one or more sources such as, for example, the communication server 110, the client device 112, the SN server 114, and/or other sources. As explained above, the interaction data 118 can relate to a user of the AMD 102 and/or a contact of the user. Thus, the interaction data 118 can be collected for the user, a contact, and/or another entity associated with the received request.

The interaction data 118 can be retrieved on demand, for example, when a request to manage social connections is received, when the functionality of the AMD 102 is invoked, or the like. Additionally, or alternatively, the interaction data 118 can be stored at a data storage location associated with one or more of the AMD 102, the communication server 110, the client device 112, and/or the SN server 114. In some embodiments, the interaction data 118 is streamed to the AMD 102 upon collection of the interaction data 118 at one or more systems or devices. If desired, the interaction data 118 is stored at one or more data storage locations.

From operation 204, the method 200 proceeds to operation 206, wherein the AMD 102 presents the interaction data 118 to the user. According to various implementations, the interaction data 118 may be provided to the user in various formats. For example, the interaction data 118 may be collected as explained above with respect to operation 204, categorized according to the type of interactions represented by the interaction data 118, and presented to the user in categories. Exemplary categories include, but are not limited to, instant messages, status updates, email messages, personal interactions, and the like. In some embodiments, the interaction data 118 further includes virtual or inferred interactions. For example, if a user and an entity associated with the request were both “tagged” in a FACEBOOK photo, share work history or educational history, have similar background information, and/or otherwise share experiences, friends, or events that may be inferred to indicate that the user and the entity know each other, the interaction data 118 can include an indication of the inferred or virtual interactions.

In another implementation, the interaction data 118 may be summarized, and a summary may be presented to the user. The summary may include samples of interactions represented by the interaction data 118. Additionally, or alternatively, the summary may include statistics and other information relating to the interactions such as, for example, the number of interactions with a particular entity, the average or median length of communications with the entity, elapsed time between messages and responses, and the like. The determination as to how to format and/or present the interaction data 118 to a user, and when to present the interaction data 118 to the user, may be determined by preferences set by a user or another authorized entity, or may be determined by the attention management module 106.

In addition to the interaction data 118 described above, other information relating to an entity associated with the request may be obtained. For example, information indicating that the entity is a highly discriminating user of a social networking service may be relevant to a friend request from the entity as it may be understood to indicate that the entity only sends requests to close or trusted friends. Similarly, information indicating that the entity is a power seller on EBAY or a power user on YELP may be understood to indicate that the entity is not a spammer, for example. Additionally, or alternatively, one or more social networks associated with the entity may be accessed by the AMD 102, and some or all of the entity's profile may be presented to the user for review with the request. Other information may be obtained, if desired.

From operation 206, the method 200 proceeds to operation 208, wherein the AMD 102 receives input from the user indicating a desired action. For example, the input may indicate that the user wishes to approve a connection request from the entity, remove the entity from a connection list, categorize the entity within one or more connection lists or categories, or the like. At operation 210, the AMD 102 updates one or more connections or connection lists as indicated by the received input. The method 200 ends at operation 212.

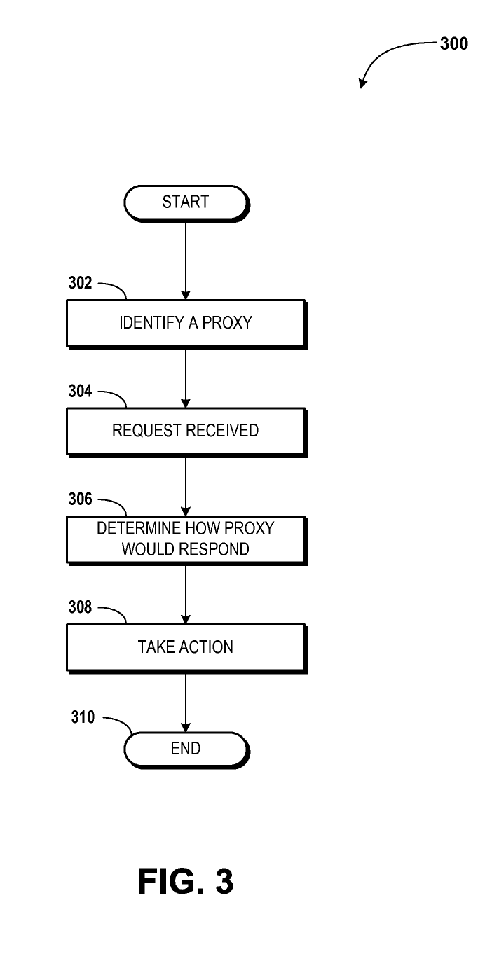

Turning now to FIG. 3, a method 300 for using a proxy to manage social connections will be described in detail. The method 300 begins at operation 302, wherein a proxy is identified. A proxy, as used herein, can be any entity that the user wants to trust with regard to social attention management. The proxy may be selected by the user, or determined by the AMD 102, subject to approval by the user.

In some embodiments, the AMD 102 identifies a proxy based upon analyzing interaction and/or communication patterns associated with the proxy, and comparing those interaction and/or communication patterns with communication and/or interaction patterns associated with the user. The interaction and/or communication patterns of the proxy and the user may be compared to identify a proxy that is believed to be similar to the user with respect to interactions and communications. Exemplary information that may be considered by the AMD 102 includes, but is not limited to, the frequency of communications and/or interactions associated with the user and/or the proxy, the entities with which the user and/or the proxy communicate, friend and/or contact lists associated with the user and/or the proxy, interaction data 118 associated with the user and/or the proxy, and the like. In some embodiments, the AMD 102 identifies one or more candidate proxies, presents the candidates to the user, and selects a proxy based upon input received from the user. It should be understood that the user may approve or disapprove of a proxy at almost any time.

From operation 302, the method 300 proceeds to operation 304, wherein the AMD 102 receives a request to manage social connections associated with a user. As noted above with respect to operation 202 of FIG. 2, the request can be a connection request, a request to remove connections, a request to categorize one or more connections, a request to expand communication channels with between an entity and the user, and the like. Furthermore, as explained above, the functionality of the AMD 102 may be invoked automatically upon receiving the request, or by receiving input from a user, the input corresponding to a command to invoke the functionality of the AMD 102.

From operation 304, the method 300 proceeds to operation 306, wherein the AMD 102 determines an action that would be taken by the proxy under circumstances similar to the received request. For example, if a particular entity is associated with the request, the AMD 102 can determine if the proxy has received a request from the entity, and if so, how the proxy responded to the request from the entity. In the case of a friend request from the entity, for example, the AMD 102 can determine if the proxy accepted the friend request from the entity or if the proxy did not accept the friend request from the entity. In some embodiments, the proxy may not have received a request similar to the request received by the user. As such, the AMD 102 may analyze the request received by the user, and compare that request to other requests received by the proxy.

If the proxy has received a request similar to the received request, the AMD 102 determines how the proxy responded to the request. If the proxy has not received a request similar to the received request, the AMD 102 can be configured to prompt the user or the proxy for instructions, to identify another proxy to handle this and/or other requests, or to analyze other activity of the proxy to determine how the proxy likely would respond to the request. It should be understood that the above examples are illustrative of possible responses to the request, and that other actions based upon the proxy are possible.

From operation 306, the method 300 proceeds to operation 308, wherein the AMD 102 takes an action determined in the operation 306. Thus, the AMD 102 may take an action similar to an action taken by the proxy, an action expected to be taken by the proxy, prompt the user for instructions, and/or identify and analyze another proxy. In operation 308, the AMD 102 may update the connections as determined in operation 306. The method 300 ends at operation 310.

Turning now to FIG. 4, a method 400 for collecting interaction data at the client device 112 will be described in detail. The method 400 begins at operation 402, wherein the client device 112 senses an interaction. As mentioned above, the interaction sensed by the client device 112 may include interactions between the user of the client device 112 and another entity, interactions between the client device 112 and other systems and/or devices, and/or communications occurring via the client device 112.

The client device 112 can sense an interaction based upon data gathered by one or more sensors 120 and/or other data. Thus, for example, the client device 112 and/or the interaction tracking application 122 may analyze a calendar associated with a user of the client device 112 to identify an anticipated meeting. Additionally, the client device 112 may analyze data collected by the sensors 120 to identify if one or more devices or systems are within communication range of a receiver or transceivers, if the client device 112 is in proximity with a location beacon, if the GPS location of the client device 112 corresponds to the location of a scheduled meeting on a calendar associated with the user of the client device 112, and the like.

From operation 402, the method 400 proceeds to operation 404, wherein the client device 112 collects the interaction data 118. As explained above, the interaction data 118 can be collected by capturing communication data passing through the client device 112, and/or by capturing data at one or more of the sensors 120. According to one embodiment, the interaction tracking application 122 is configured to activate a speaker of the client device 112 at the beginning of a sensed interaction to record the interaction. It should be understood that the client device 112 can record a portion of the interaction, the beginning of the interaction, and/or the end of the interaction, depending upon preferences and/or hardware or software capabilities. For example, the client device 112 can be configured to record a specified number of seconds of audio any time the client device 112 senses another device within a defined proximity. In some embodiments, the client device 112 is configured to sample audio according to a defined schedule, e.g., every thirty seconds, every five minutes, or the like.

According to various implementations, the client device 112 is configured to prompt a user after any recorded interaction. For example, the client device 112 may prompt the user to identify the person with whom the user was speaking, to record a note, to categorize the person, to request a vcard form the person, to send an invitation to the person, and the like. In some embodiments, all conversations recorded during a day or week are reviewable by the user at a desired time.

It should be understood that the client device 112 can connect to other devices including, but not limited to, a device associated with an entity with whom the user is interacting. Thus, the client device 112 may connect to a device associated with the entity to obtain identity information, contact information, and the like. The client device 112 also can capture video and/or photographic information during an interaction, if desired.

From operation 404, the method 400 proceeds to operation 406, wherein the client device 112 senses an end of the interaction. In some embodiments, the client device 112 senses an end of the interaction by determining that a device that was proximate to the client device 112 has moved out of proximity with the client device 112, thereby indicating that a user associated with the device has moved out of proximity with the user. In some embodiments, the client device 112 senses an end of the interaction based upon input received from the user, the input indicating that the interaction is over. In other embodiments, the client device 112 determines that the interaction has ended based upon an interruption sensed at the client device 112 such as, for example, reception of a telephone call at the client device 112 or another device with which the client device 112 is communicating.

The client device 112 also can sense an end of the interaction by determining that the client device 112 and/or the device with which the client device 112 is communicating has deliberately interrupted communications, received or sent one or more messages, that the time allotted for a scheduled meeting associated with the interaction as ended, and the like.

From operation 406, the method 400 proceeds to operation 408, wherein the client device 112 stores or transfers the collected interaction data 118. In some embodiments, the interaction data 118 is streamed to the AMD 102 during interactions. In other embodiments, the interaction data 118 is stored in a data storage device associated with the AMD 102, the communication server 110, the client device 112, the SN server 114, and/or another device, and retrieved by or transferred to the AMD 102 based upon a schedule, when requested by the AMD 102, or based upon other activity. The method 400 ends at operation 410.

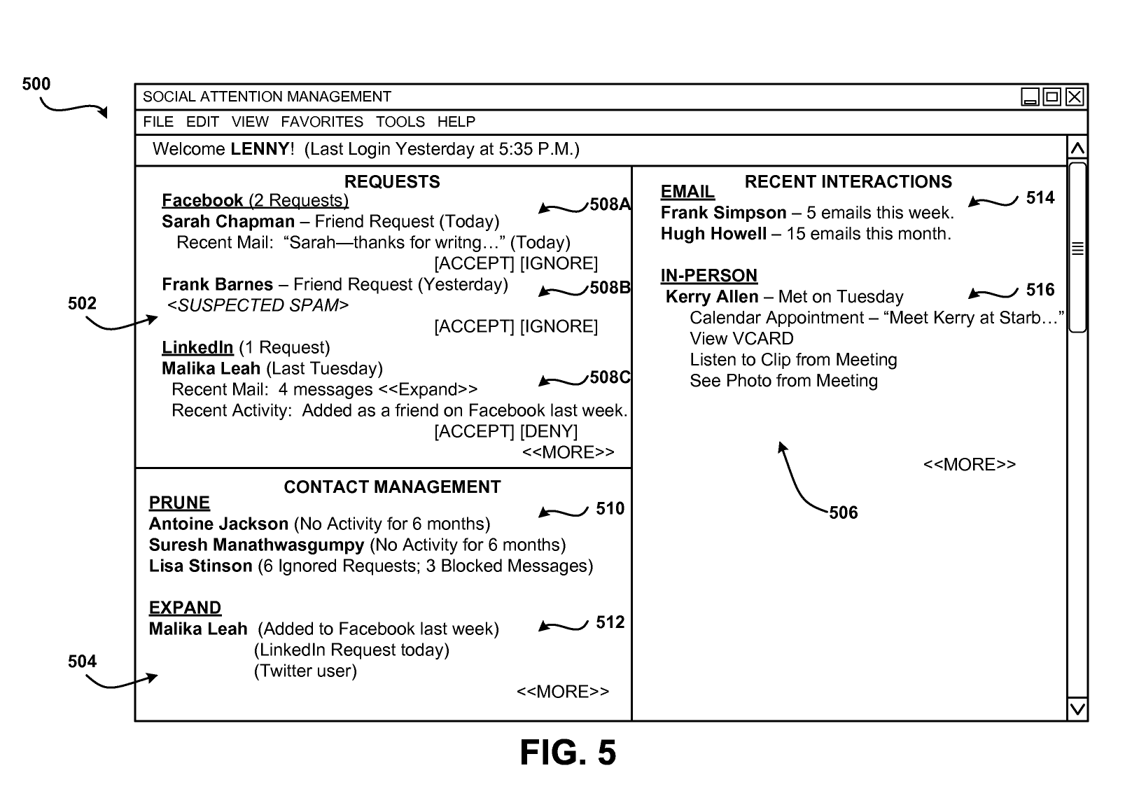

Although not illustrated in FIG. 4, the client device 112 and/or the AMD 102 can be configured to follow-up with a user regarding interactions associated with the user. For example, the AMD 102 may be configured to remind a user of all interactions the user was party to on a daily, semi-daily, weekly, bi-weekly, semi-weekly, monthly, semi-monthly, bi-monthly, or other basis. Additionally, or alternatively, the AMD 102 may be configured to provide a follow-up on any interaction when the interaction ends, as mentioned above with reference to operation 404. An exemplary display for following-up with the user is described below with reference to FIG. 5.

Turning now to FIG. 5, a user interface diagram showing aspects of a user interface (UI) for providing social attention management information to a user in one embodiment will be described. In particular, FIG. 5 shows a screen display 500 generated by the attention management application 106 according to one particular implementation presented herein. In this implementation, the attention management application 106 includes a stand-alone application for interacting with the communication server 110, the client device 112, and one or more SN servers 114. It should be appreciated that the display illustrated in FIG. 5 is exemplary.

The screen display 500 shown in FIG. 5 includes various tool bar and menu items. It should be understood that the illustrated tool bar and menu items are merely illustrative, and that additional and/or alternative tool bar and/or menu items are possible and are contemplated. In the illustrated embodiment, the screen display 500 further includes a requests section 502, a contact management section 504, and a recent interactions section 506. It should be understood that additional and/or alternative sections may be included, and that the illustrated format of the sections 502, 504, 506 is merely exemplary.

The requests section 502 includes requests gathered from one or more SN servers 114. In the illustrated embodiments, the requests section 502 includes two requests 508A, 508B gathered from a first SN server 114, and one request 508C gathered from a second SN server 114. As illustrated, the requests 508A-C can be presented with interaction data 118 to provide context for the user. The interaction data 118 may be used by the user to determine if the user knows an entity associated with the requests 508A-C. In some embodiments, the AMD 102 is configured to identify suspected fraudulent and/or SPAM activity and to provide that information to the user, as illustrated with respect to the request 508B. As illustrated with respect to the request 508C, the AMD 102 may be configured to identify communications over multiple channels, and to provide this information to the user for consideration as well.

The contact management section 504 can include various suggested contact management actions for a user. In the illustrated embodiment, the contact management section 504 includes a prune section 510 with contacts suggested for pruning or removal. In the illustrated embodiment, one or more reasons for the suggested pruning of a contact are presented with each contact listed in the prune section 510. In the provided examples, a lack of interactions between the user and the contacts in the prune section 510 and/or messages associated with an entity that are blocked, filtered, and/or ignored may be indicated by the AMD 102 as reasons to prune a contact. It should be understood that these examples are illustrative, and that additional and/or alternative reasons for pruning contacts may be provided.

The contact management section 504 further can include an expand section 512. The expand section 512 may include one or more contacts with whom the user is connected with which the AMD 102 suggests additional or expanded interactions. In the illustrated embodiment, the contact listed in the expand section 512 is presented with various information supporting the suggestion from the AMD 102 to expand communications with the contact. It should be understood that the illustrated supporting information is merely illustrative.

The recent interactions section 506 can be used to present interaction data 118 to a user. In the illustrated embodiment, the recent interactions section 506 includes an email section 514, which can be used to display interaction data 118 relating to recent email exchanges. It should be understood that the email section 514 can be configured to show contacts with whom the user has had email exchanges, if desired, instead of, or in addition to, presenting all emails associated with the user.

The recent interactions section 506 also can include an in-person section 516 for presenting information from in-person interactions such as those described with reference to FIG. 4. In the illustrated embodiment, the in-person section 516 includes a representation for one in-person interaction, and presents links for viewing a calendar appointment associated with the in-person meeting, a vcard obtained during the in-person meeting, an audio clip associated with the in-person meeting, and a photo taken during the meeting. It should be understood that additional and/or alternative information can be presented, if desired, and that the illustrated embodiment is exemplary.

At any given time, a user may have numerous decisions to make regarding friend requests, contact lists, categorization schemes, how and what to read from numerous contacts and/or friends, and the like. Thus, for many users, it may be difficult to decide how to manage their attention, in terms of consuming updates/articles/TWEETS, and the like. The above-described concepts and technologies for can be used to simplify these questions by providing social attention management for the user.

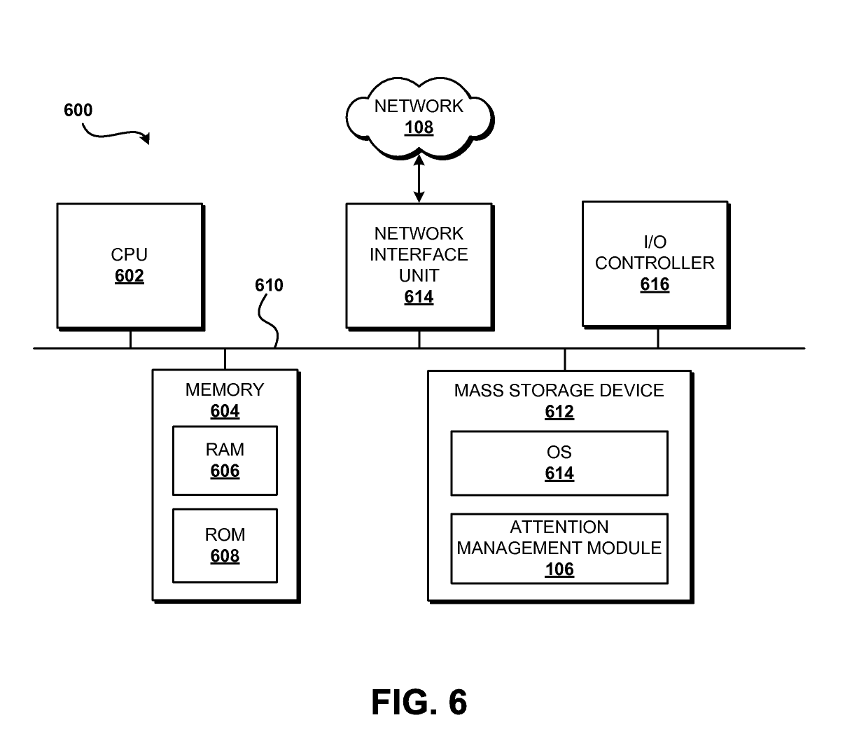

FIG. 6 illustrates an exemplary computer architecture 600 for a device capable of executing the software components described herein for social attention management as described above. Thus, the computer architecture 600 illustrated in FIG. 6 illustrates an architecture for a server computer, mobile phone, a PDA, a smart phone, a server computer, a desktop computer, a netbook computer, a tablet computer, and/or a laptop computer. The computer architecture 600 may be utilized to execute any aspects of the software components presented herein, including the operating system 104, the attention management module 106, and/or other software.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the operating system 104 and the attention management module 106. The mass storage device 612 also can be configured to store data such as the interaction data 118.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media that can be accessed by the computer architecture 600.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of this specification and the claims, the phrase “computer-readable storage medium” and variations thereof, does not include waves, signals, and/or other transitory and/or intangible communication media.

According to various embodiments, the computer architecture 600 may operate in a networked environment using logical connections to remote computers through a network such as the network 108. The computer architecture 600 may connect to the network 108 through a network interface unit 614 connected to the bus 610. It should be appreciated that the network interface unit 614 also may be utilized to connect to other types of networks and remote computer systems, for example, the communication server 110, the client device 112, and the SN server 114. The computer architecture 600 also may include an input/output controller 616 for receiving and processing input from a number of other devices, including a keyboard, mouse, or electronic stylus (not shown in FIG. 6). Similarly, the input/output controller 616 may provide output to a display screen, a printer, or other type of output device (also not shown in FIG. 6).

As mentioned briefly above, a number of program modules and data files may be stored in the mass storage device 612 and RAM 606 of the computer architecture 600, including an operating system 104 suitable for controlling the operation of the server, desktop, and/or laptop computer. The mass storage device 612 and RAM 606 also may store other types of program modules and data.

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

Based on the foregoing, it should be appreciated that technologies for social attention management have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

I claim:

1. A computer-implemented method for social attention management, the computer-implemented method comprising performing computer-implemented operations for:
receiving a request relating to one or more contacts, the request comprising one or more of
a request to add the one or more contacts to a contact list associated with a user,
a request to remove the one or more contacts from the contact list,
a request to organize the one or more contacts in the contact list, or
a request to expand communications between the user and the one or more contacts;
obtaining interaction data relating to at least one of the contacts or the user;
determining an action to take in response to the request; and
executing the determined action with respect to the one or more contacts.

2. The method of claim 1, wherein the interaction data comprises social networking data relating to at least one of the one or more contacts and the user.

3. The method of claim 1, wherein obtaining the interaction data comprises collecting the interaction data at a client device associated with the user.

4. The method of claim 3, wherein obtaining the interaction data further comprises:
sensing an interaction;
collecting the interaction data, in response to sensing the interaction; and
storing the interaction data.

5. The method of claim 4, wherein sensing the interaction comprises determining that a device associated with the contact is proximate to the client device.

6. The method of claim 4, wherein collecting the interaction data comprises capturing audio at the client device.

7. The method of claim 4, wherein collecting the interaction data comprises establishing a data connection between the client device and the device and receiving contact information associated with the contact via the data connection.

8. The method of claim 4, wherein sensing the interaction further comprises:
obtaining calendar data from a calendar associated with the user;
obtaining location data at the client device; and
determining that the interaction is occurring based, at least partially, upon analysis of the location data and the calendar data.

9. The method of claim 1, wherein the interaction data comprises communication data relating to communications associated with at least one of the one or more contacts and the user.

10. The method of claim 1, wherein the request comprises a request to add a contact to a contact list associated with the user.

11. The method of claim 1, wherein the request comprises a request to prune a contact from a contact list associated with the user.

12. The method of claim 1, wherein determining the action comprises presenting the request and the interaction data to the user and receiving input from the user in response to the presenting.

13. The method of claim 1, wherein determining the action comprises:
identifying a proxy associated with the user; and
analyzing the proxy to determine how the proxy would respond to the request.

14. The method of claim 13, wherein identifying the proxy comprises receiving from the user an input identifying the proxy.

15. The method of claim 13, wherein identifying the proxy comprises:
comparing social networking activity associated with the user to social networking activity associated with the proxy; and
determining, based upon the comparing, that the proxy and the user have similar social networking activity.

16. The method of claim 1, wherein the request comprises a request to expand communications between the one or more contacts and the user.

17. A computer-readable storage medium having computer-readable instructions stored thereupon that, when executed by a computer, cause the computer to:
receive a request relating to one or more contacts, the request being associated with a user of a social networking service, and the request comprising one or more of
a request to add the one or more contacts to a contact list associated with the user,
a request to remove the one or more contacts from the contact list,
a request to organize the one or more contacts in the contact list, or
a request to expand communications between the user and the one or more contacts;
obtaining interaction data relating to at least one of the contacts or the user;
determining an action to take in response to the request; and
executing the determined action with respect to the one or more contacts.

18. The computer-readable storage medium of claim 16, wherein obtaining the interaction data comprises:
receiving user social networking data relating to the user and receiving contact social networking data relating to the one or more contacts, the user social networking data and the contact social networking data being received from one or more social networking servers; and
receiving communications data from one or more communications servers, the communications data comprising data relating to communications associated with at least one of the one or more contacts and the user.

19. The computer-readable storage medium of claim 17, wherein obtaining the interaction data comprises:
sensing an interaction at a client device associated with the user, the interaction comprising an in-person interaction between the user and at least one of the one or more contacts;
collecting the interaction data, in response to sensing the interaction; and
storing the interaction data at a data storage location.

20. A computer-readable storage medium having computer-readable instructions stored thereupon that, when executed by a computer, cause the computer to:
receive a request relating to one or more contacts, the request being associated with a user of a social networking service and comprising one or more of
a request to add the one or more contacts to a contact list associated with the user,
a request to remove the one or more contacts from the contact list,
a request to organize the one or more contacts in the contact list, or
a request to expand communications between the user and the one or more contacts;
obtain interaction data relating to at least one of the contacts or the user, the interaction data comprising social networking data received from one or more social networking servers, communications data from one or more communication servers, and data collected by a client device associated with the user, wherein collecting the data comprises
sensing an interaction at the client device using one or more sensors of the client device and an interaction tracking application executing on the client device, the interaction comprising an interaction between the user and at least one of the one or more contacts, and
collecting the interaction data in response to sensing the interaction;
determine an action to take in response to the request, the action comprising one or more of
accepting the request to add the one or more contacts,
denying the request to add the one or more contacts,
removing the one or more contacts,
organizing the one or more contacts into contact lists, or
expanding communications between the user and the one or more contacts; and
execute the determined action with respect to the one or more contacts.
